(19) United States
(12) Patent Application Publication
(10) Pub. No.: US 2024/0281209 A1
(43) Pub. Date: Aug. 22, 2024

(54) MACHINE LEARNING OPTIMIZATION CIRCUIT AND METHOD THEREOF

(71) Applicant: DELTA ELECTRONICS, INC., Taoyuan City (TW)

(72) Inventors: Chieh-Fu TSAI, Taoyuan City (TW); Chia-Hsiang YANG, Taoyuan City (TW); Cheng-Yan DU, Taoyuan City (TW)

(21) Appl. No.: 18/358,918

(22) Filed: Jul. 25, 2023

(30) Foreign Application Priority Data
Feb. 17, 2023 (TW) 112105861

(51) Int. Cl. G06F 7/544; G06F 7/32; G06F 7/53

(52) U.S. Cl. CPC G06F 7/5443; G06F 7/32; G06F 7/5318; G06F 7/5324

(57) ABSTRACT

A machine learning optimization circuit and a method thereof are provided. The method includes steps of: generating a local feature matrix from an extraction range in a feature tensor matrix, and the local feature matrix includes feature values of X columns, Y rows, and Z channels; partitioning W sub-feature matrices from the local feature matrix, and each of the W sub-feature matrices includes X×Y×Z/W feature values; simultaneously performing parallel dot product operations on the W sub-feature matrices by W×K parallel operation modules to generate W×K temporary feature matrices; and integrating the W×K temporary feature matrices into a local feature output matrix corresponding to the local feature matrix, and the local feature output matrix includes feature values of X columns, Y rows, and Z channels.

### CROSS - REFERENCE TO RELATED APPLICATION

This application claims priority to Taiwan Application Serial Number 112105861, filed on Feb. 17, 2023, which is herein incorporated by reference in its entirety.

### BACKGROUND

### Field of Disclosure

The present disclosure relates to a machine learning optimization circuit and a method thereof.

### Description of Related Art

For current machine learning technology, convolution calculation is often complex and complicated, which often consumes a lot of resources and time. In view of this, it is necessary to improve the convolution calculation in terms of hardware or software to achieve acceleration of the convolution calculation. However, the current technology is not yet mature for the acceleration of the convolution calculation, and there are still many deficiencies. In addition, the data movement amount of partial sums and reuse of data are also issues that need to be further considered in the convolution calculation.

### SUMMARY

The disclosure provides a machine learning optimization method, comprising: generating a local feature matrix from an extraction range in a feature tensor matrix, wherein the local feature matrix comprises feature values of X columns, Y rows, and Z channels; partitioning W sub-feature matrices from the local feature matrix, wherein each of the W sub-feature matrices comprises X×Y×Z/W feature values; simultaneously performing parallel dot product operations on the W sub-feature matrices by W×K parallel operation modules to generate W×K temporary feature matrices, wherein the W×K parallel operation modules correspond to K kernels, each of the kernels comprises weight values of M columns, N rows, and Z channels, and each of temporary feature matrices comprises X×Y/W feature values, wherein the parallel dot product operation comprises: each of the parallel operation modules is configured for multiplying one of the weight values of the single kernel by the X×Y×Z/W feature values, and every W parallel operation modules is configured for multiplying the one of the weight values of the single kernel by the feature values of X columns, Y rows, and Z channels; and integrating the W×K temporary feature matrices into a local feature output matrix corresponding to the local feature matrix, wherein the local feature output matrix comprises feature values of X columns, Y rows, and Z channels.

The disclosure further provides a machine learning optimization circuit, which comprises a data dispatcher, a multiplier array and a tensor combiner. The data dispatcher is configured for generating a local feature matrix from an extraction range in a feature tensor matrix, and the local feature matrix comprises feature values of X columns, Y rows, and Z channels, wherein the data dispatcher is further configured for partitioning W sub-feature matrices from the local feature matrix, wherein each of the W sub-feature matrices comprises X×Y×Z/W feature values. The multiplier array is connected to the data dispatcher. The tensor combiner is connected to the multiplier array, wherein the multiplier array and the tensor combiner are configured for simultaneously performing parallel dot product operations on the W sub-feature matrices by W×K parallel operation modules to generate W×K temporary feature matrices, wherein the W×K parallel operation modules correspond to K kernels, each of the kernels comprises weight values of M columns, N rows, and Z channels, and each of temporary feature matrices comprises X×Y/W feature values, wherein the parallel dot product operation comprises: each of the parallel operation modules is configured for multiplying one of the weight values of the single kernel by the X×Y×Z/W feature values, and every W parallel operation modules is configured for multiplying the one of the weight values of the single kernel by the feature values of X columns, Y rows, and Z channels, wherein the multiplier array is further configured for integrating the W×K temporary feature matrices into a local feature output matrix corresponding to the local feature matrix, wherein the local feature output matrix comprises feature values of X columns, Y rows, and Z channels.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a machine learning optimization circuit 100 according to some embodiments of the present disclosure.

FIG. 2 is a schematic diagram illustrating processing multiple feature tensor matrices to generate multiple combined feature output matrices according to some embodiments of the present disclosure.

FIG. 3 is a flowchart illustrating a machine learning optimization method according to some embodiments of the present disclosure.

FIG. 4 is a schematic diagram illustrating processing of the feature tensor matrix according to some embodiments of the present disclosure.

FIG. 5 is a schematic diagram illustrating an element-by-element multiplication operation between elements in some embodiments of the present disclosure.

FIG. 6 is a schematic diagram of multiple parallel operation modules in some embodiments of the present disclosure.

FIG. 7 is a schematic diagram illustrating the processing of the feature tensor matrix according to other embodiments of the present disclosure.

FIG. 8 is a schematic diagram illustrating the element-by-element multiplication operation according to other embodiments of the present disclosure.

FIG. 9 is a schematic diagram illustrating multiple parallel operation modules in other embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In past machine learning technology, convolution calculations often need to consume a lot of resources and time. However, current technology is not yet mature for accelerating the convolution calculations, and there are still many deficiencies. In view of this, the disclosure proposes a machine learning optimization circuit and method, which combines KC-partitioning calculation of a weight domain and a channel domain, XY-partitioning calculation of a column domain and a row domain and parallel convolution operations in order to greatly reduce computing resources and computing speed, thereby minimizing data moving amount of partial sums and improving data reusing.

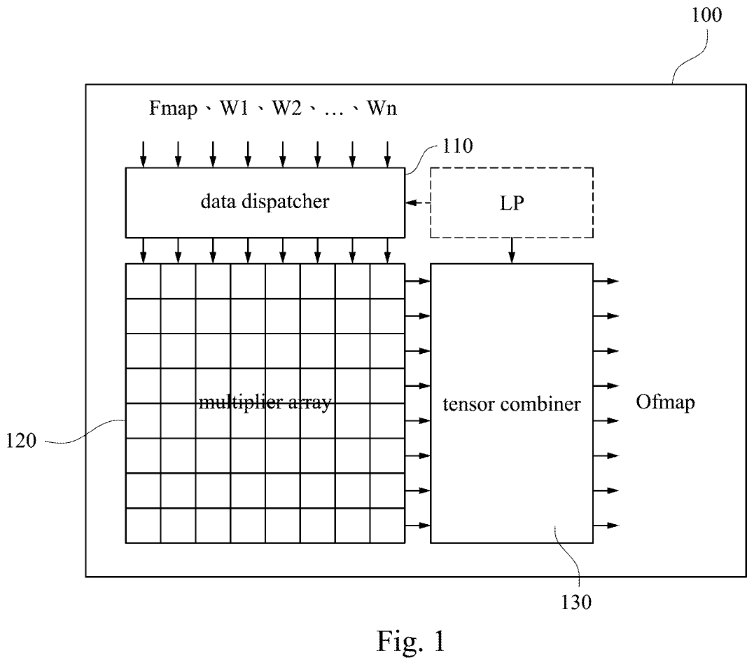

Reference is made to FIG. 1, which is a schematic diagram illustrating a machine learning optimization circuit 100 according to some embodiments of the present disclosure. As shown in FIG. 1, the machine learning optimization circuit 100 includes a data dispatcher 110, a multiplier array 120 and a tensor combiner 130. The data dispatcher 110 is connected to the multiplier array 120. The multiplier array 120 is connected to a tensor combiner 130.

In some embodiments, the machine learning optimization circuit 100 can be implemented by a dedicated logic circuit, for example, a field programmable gate array (FPGA) or an application specific integrated circuit (ASIC).

In some embodiments, the data dispatcher 110 can be implemented by any processing circuit having a processing unit. In some embodiments, the multiplier array 120 can be composed of multiple adder circuits of any type. In some embodiments, the tensor combiner 130 can be implemented by a processing circuit having an adder tree structure.

In this embodiment, the machine learning optimization circuit 100 can input an original matrix fmap and multiple kernels W1-WK to the data dispatcher 110. The multiplier array 120 is used for performing multiple multiplication operations. The tensor combiner 130 generates an operation result Ofmap of a convolution operation between the original matrix fmap and the kernels W1-WK.

In some embodiments, the machine learning optimization circuit 100 can receive the original matrix fmap from the outside, or pre-store the original matrix fmap in a memory. In some embodiments, the data dispatcher 110 can partition the original matrix fmap into multiple parts of same size, and use these parts as feature tensor matrices respectively. In some embodiments, the original matrix fmap can be any feature map generated in a machine learning model, where the feature map can include feature values of A columns, B rows, and C channels, where A, B, and C can be any positive integers.

Generation of the disclosed feature tensor matrix is illustrated below with practical examples.

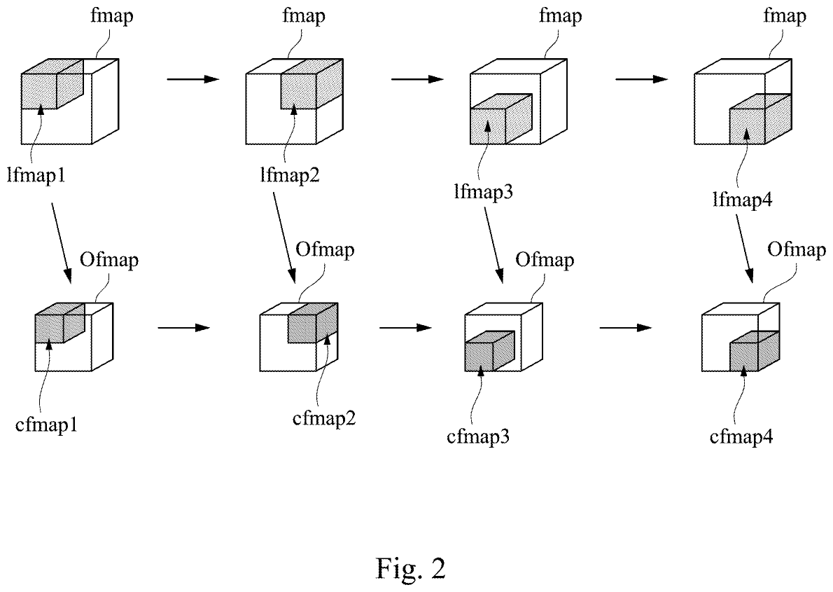

Reference is made to FIG. 2 together, which is a schematic diagram illustrating processing multiple feature tensor matrices Ifmap1-Ifmap4 to generate multiple combined feature output matrices cfmap1-cfmap4 according to some embodiments of the present disclosure. As shown in FIG. 2, the original matrix fmap can be partitioned into four feature tensor matrices Ifmap1-Ifmap4. For example, assuming that the original matrix fmap includes feature values of A columns, B rows, and C channels, each of the feature tensor matrices Ifmap1-Ifmap4 includes feature values of A/2 columns, B/2 rows, and C channels. Next, the feature tensor matrices Ifmap1-Ifmap4 are processed by the kernels W1-WK to generate 4 combined feature output matrices cfmap1-cfmap4 (a matrix with one channel will be generated after processing by each kernel, and currently there are 8 kernels. Therefore, the kernel acceleration is 8, and a combined feature output matrix of 8 channels will be generated after processing by 8 kernels), and the combined feature output matrices cfmap1-cfmap4 can be combined to generate the operation result Ofmap. It should be noted that, assuming that an extraction range used for each calculation is a size of the X columns, Y rows, and Z channels, and each of the kernels W1-WK are a size of the M columns, N rows, Z channels, Z is equal to C, X+M−1 is equal to A/2, Y+N−1 is equal to B/2, and each of combined feature output matrices includes feature values of X columns, Y rows, and Z channels, where X, Y, and Z are all positive integers set by an operation parameter LP. In addition, such a method will greatly reduce space for storing data.

In order to clearly illustrate the machine learning optimization method disclosed in the present disclosure, the machine learning optimization method performed on one Ifmap1 of the feature tensor matrices will be taken as an example below.

In some embodiments, the machine learning optimization circuit 100 can store K kernels W1-WK of a machine learning model (e.g., a convolutional neural network), and each kernel includes weight values of M columns, N rows, and Z channels, where M, N, K, and Z can be any positive integers, M can be equal to or not equal to N, and the kernels W1-WK are used to convolve the original matrix fmap. For example, the machine learning optimization circuit 100 can further include a memory (not shown), which can store the kernels W1-WK, the original matrix fmap, the operation result Ofmap, temporary data generated during calculation processing, etc.

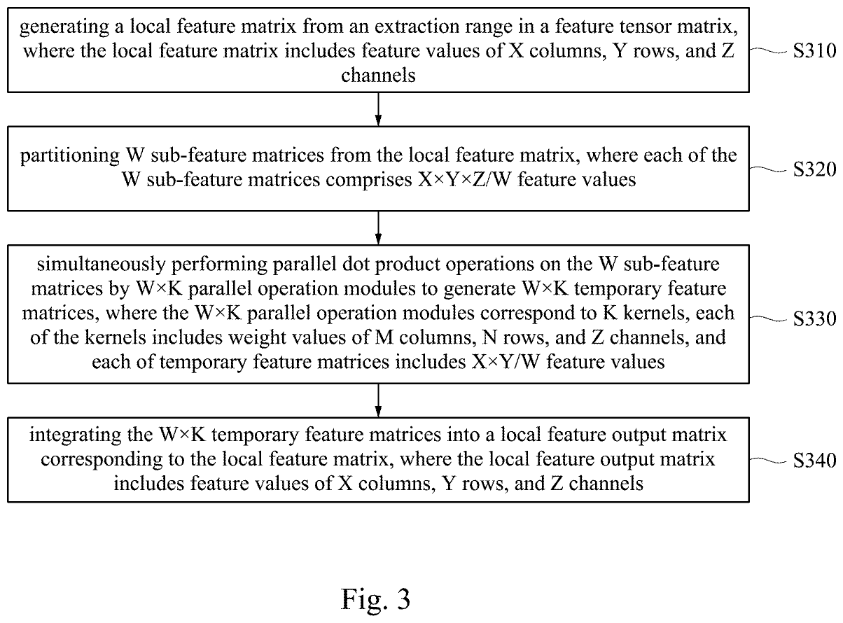

Reference is made to FIG. 3 together, which is a flowchart illustrating a machine learning optimization method according to some embodiments of the present disclosure. As shown in FIG. 3, the components in the machine learning optimization device 100 in FIG. 1 are used for executing steps S310-S350 in the machine learning optimization method. As shown in FIG. 3, firstly, in step S310, a local feature matrix is generated from the extraction range in the feature tensor matrix Ifmap1, and the local feature matrix includes feature values of X columns, Y rows, and Z channels, where X can be a positive integer equal to a quantity of columns of the feature tensor matrix Ifmap1 minus M plus 1, Y can be a positive integer equal to a quantity of rows of the feature tensor matrix Ifmap1 minus N plus 1, and Z can be a positive integer equal to a quantity of channels of the feature tensor matrix Ifmap1. In some embodiments, the extraction range can be a range of X columns, Y rows, and Z channels in the feature tensor matrix Ifmap1.

In some embodiments, the machine learning optimization circuit 100 can input the operation parameter LP to the data dispatcher 110 and the tensor combiner 130. In some embodiments, the operational parameters LP can include a column parameter, a row parameter, a kernel parameter, and a channel parameter, where the column parameter can indicate a quantity of columns in the above-mentioned extraction range, the row parameter can indicate a quantity of rows in the above-mentioned extraction range, the kernel parameter can indicate a quantity of kernels for convolving the feature tensor matrix Ifmap1 (i.e., a quantity K of the above-mentioned kernels W1-WK), and the channel parameter can indicate a quantity of channels of the above-mentioned extraction range. In some embodiments, the data dispatcher 110 can partition the local feature matrix from the extraction range in the feature tensor matrix Ifmap1 according to the operation parameter LP. In other words, the local feature matrix can include a part of feature values in the feature tensor matrix Ifmap1, and the operation parameter LP can be used to determine parallelism of each operation (i.e., resources required for a single operation).

Furthermore, in step S320, W sub-feature matrices are partitioned from the local feature matrix, and each of the W sub-feature matrices includes X×Y×Z/W feature values, where W is any positive integer less than X×Y. In some embodiments, W can be preset by a user. In some embodiments, the data dispatcher 110 can partition each row from the local feature matrix to generate Y (in this case, W is equal to Y) sub-feature matrices. In some embodiments, the data dispatcher 110 can partition each column from the local feature matrix to generate X (in this case, W is equal to X) sub-feature matrices. In some embodiments, the data dispatcher 110 can randomly select Xx Y/W feature values of 1 column, 1 row, and Z channels from the local feature matrix as the one sub-feature matrix, and randomly generate the W-1 other sub-feature matrices in a method of not repeating the selection.

Furthermore, in step S330, simultaneously parallel dot product operations is performed on the W sub-feature matrices by W×K parallel operation modules to generate W×K temporary feature matrices, where W×K parallel operation modules correspond to K kernels W1-WK, each kernel includes weight values of M columns, N rows, and Z channels, and each temporary feature matrix includes X×Y/W feature values. In this embodiment, the parallel dot product operation includes: each of the parallel operation modules is used for multiplying one of the weight values of the single kernel by X×Y×Z/W feature values, and every W parallel operation modules is used for multiplying the one of the weight values of the single kernel by the feature values of X columns, Y rows, and Z channels.

In some embodiments, each parallel operation module includes X×Y×K/W multiplier modules and an adder tree module. In some embodiments, these parallel operation modules can be implemented by the multiplier array 120 and the tensor combiner 130. In some embodiments, the multiplier array 120 can include the X×Y×K/W multiplier modules, and the tensor combiner 130 can include the adder tree module. In some embodiments, the multiplier array 120 can use perform an element-by-element multiplication operation on the X×Y×Z/W feature values in one of the sub-feature matrices with the one of the weight values of the single kernel by the X×Y×K/W multiplier modules, so as to generate X×Y×K/W product values. Next, the tensor combiner 130 can convert the X×Y×K/W product values into one of the temporary feature matrices by the adder tree module.

In some embodiments, the adder tree module includes X×Y/W accumulator modules. In some embodiments, the tensor combiner 130 can sum every Z product values by the adder tree module to generate X×Y/W product sums, and store the X×Y/W product sums in the X×Y/W accumulator modules in the adder tree module.

Furthermore, in step S340, the W×K temporary feature matrices are integrated into a local feature output matrix corresponding to the local feature matrix, where the local feature output matrix includes feature values of X columns, Y rows, and Z channels. In some embodiments, the tensor combiner 130 can sequentially combine every W temporary feature matrices to generate K combination matrices, and integrate these K combination matrices into the local feature output matrix, where each combination matrix includes feature values of X columns, Y rows, and 1 channel. In some embodiments, a quantity of these parallel operation modules is equal to a product of a quantity of rows of the local feature matrix and a quantity of these kernels W1-WK.

In some embodiments, after generating the local feature output matrix corresponding to the local feature matrix, the data dispatcher 110 can change the extraction range to generate another extraction range. In some embodiments, the data dispatcher 110 can generate another local feature matrix from the other extracted range in the feature tensor matrix, and the other local feature matrix includes feature values of X columns, Y rows, and Z channels. Next, the data dispatcher 110 can partition W other sub-feature matrices from the other local feature matrix, where each of the W other sub-feature matrices includes X×Y×Z/W feature values. Next, the multiplier array 120 and the tensor combiner 130 can simultaneously perform the parallel dot product operations on the W sub-feature matrices by W×K parallel operation modules to generate W×K other temporary feature matrices, and integrate the W×K other temporary feature matrices into another local feature output matrix corresponding to the other local feature matrix, where the other local feature output matrix includes feature values of X columns, Y rows, and Z channels.

In some embodiments, the tensor mixer 130 can perform an element-by-element addition operation on the generated local feature output matrix with the other local feature output matrix, so as to generate a combined feature output matrix cfmap1. In some embodiments, after generating the combined feature output matrix cfmap1, the data dispatcher 110 can change the above-mentioned extraction range again to generate another extraction range, and perform the same operations as above until all the feature values in the feature tensor matrix have been processed by the W×K parallel operation modules. In some embodiments, a quantity of the generated extraction ranges can be M×N. In other words, the above machine learning optimization method can be executed M×N times, and M×N local feature output matrices can be performed the element-by-element addition operation to generate the combined feature output matrix cfmap1, where the combined feature output matrix cfmap1 is a convolution result between the feature tensor matrix Ifmap1 and the kernels W1-WK.

The method in detail will be further described in following embodiments, and the above-mentioned machine learning optimization method will be described below with two practical examples.

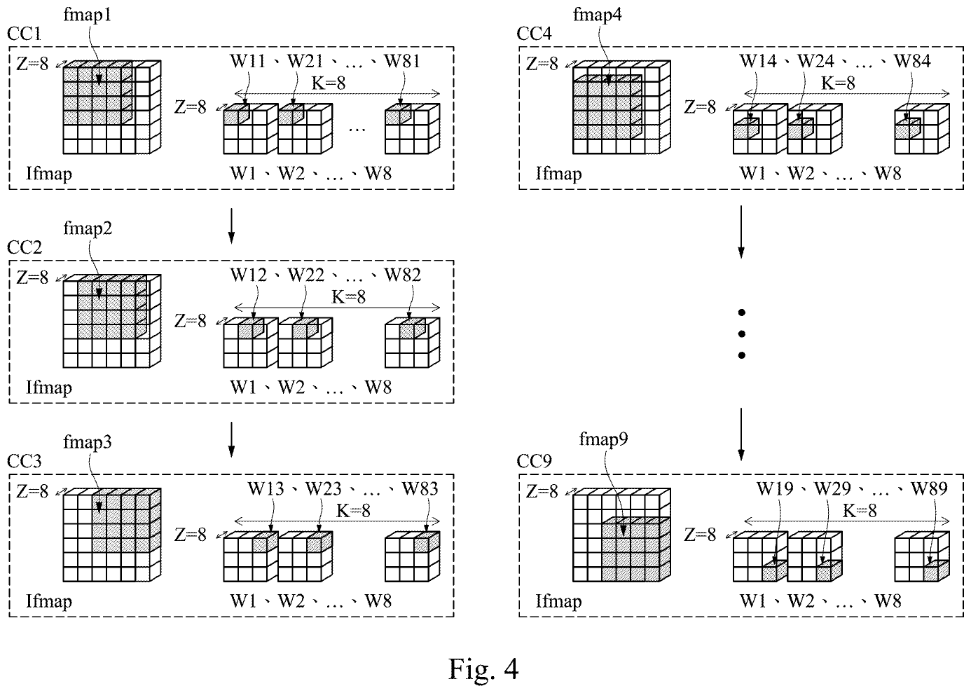

Please refer to FIG. 4, which is a schematic diagram illustrating processing of the feature tensor matrix Ifmap (e.g., one of the above-mentioned feature tensor matrices Ifmap1-Ifmap8) according to some embodiments of the present disclosure. As shown in FIG. 4, assuming that the feature tensor matrix Ifmap includes feature values of 6 columns, 6 rows, and 8 channels and X, Y, Z, K, M, N (i.e., the operation parameter LP) are 4, 4, 8, 8, 3, 3 respectively, In a first cycle CC1, the local feature matrix fmap1 can be partitioned from a first extraction range in the feature tensor matrix Ifmap, and 4 sub-feature matrices can be partitioned from the local feature matrix fmap1, where each sub-feature matrix includes feature values of 4 columns, 1 rows, and 8 channels. In other words, each row in the local feature matrix fmap1 can be partitioned (at this time, W is equal to Y). Next, 8 weight values W11-W81 of 1 column, 1 row, and 8 channels can be partitioned from the 8 kernels W1-W8.

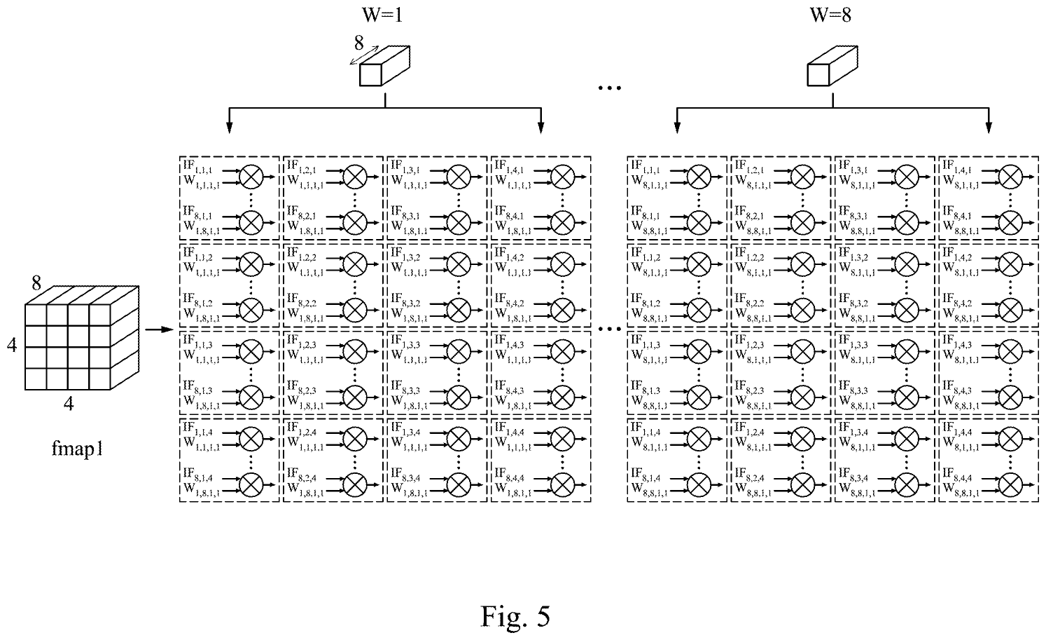

Furthermore, reference is made to FIG. 5 together, which is a schematic diagram illustrating the element-by-element multiplication operation between elements in some embodiments of the present disclosure. As shown in FIG. 5, take the local feature matrix fmap1 and the weight values W11-W81 partitioned in the first cycle CC1 as an example.

A part of a first column and a first row of the local feature matrix fmap1 includes elements IF_{1, 1, 1}-IF_{8, 1, 1}, a part of a second column and the first row of the local feature matrix fmap1 includes elements IF_{1, 1, 2}-IF_{8, 1, 2}, a part of a third column and the first row of the local feature matrix fmap1 includes elements IF_{1, 1, 3}-IF_{8, 1, 3}, and a part of a fourth column and the first row of the local feature matrix fmap1 includes elements IF_{1, 1, 4}-IF_{8, 1, 4}. Next, these elements can be partitioned from the local feature matrix fmap1 as a first sub-feature matrix.

A part of the first column and the second row of the local feature matrix fmap1 includes elements IF_{1, 2, 1}-IF_{8, 2, 1}, a part of the second column and the second row of the local feature matrix fmap1 includes elements IF_{1, 2, 2}-IF_{8, 2, 2}, a part of the third column and the second row of the local feature matrix fmap1 includes elements IF_{1, 2, 3}-IF_{8, 2, 3}, and a part of the fourth column and the second row of the local feature matrix fmap1 includes elements IF_{1, 2, 4}-IF_{8, 2, 4}. Next, these elements can be partitioned from the local feature matrix fmap1 as a second sub-feature matrix. By analogy, third to fourth sub-feature matrices can be partitioned from the local feature matrix fmap1 by the same method.

Furthermore, the weight value W11 includes elements W_{1, 1, 1, 1}-W_{1, 8, 1, 1}. The first to fourth sub-feature matrices can be performed the element-by-element multiplication operation with the weight value W11 respectively.

In detail, the element-by-element multiplication operation is performed on feature values of 1 column, 1 row, and 8 channels of first one in the first sub-feature matrix with the weight value W11 to generate 8 product values, and these 8 product values are summed to generate 1 product sum. In other words, the elements IF_{1, 1, 1}-IF_{8, 1, 1} can be multiplied and added with the elements W_{1, 1, 1, 1}-W_{1, 8, 1, 1} respectively (i.e., dot product) to generate 1 product sum. Next, the element-by-element multiplication operation is performed on feature values of 1 column, 1 row, and 8 channels of second one in the first sub-feature matrix with the weight value W11 to generate 8 product values, and these 8 product values are summed to generate 1 product sum. In other words, the elements IF_{1, 1, 2}-IF_{8, 1, 2} can be multiplied and added with the elements W_{1, 1, 1, 1}-W_{1, 8, 1, 1} respectively to generate 1 product sum. By analogy, the element-by-element multiplication operation on the entire first sub-feature matrix with the weight value W11 can be completed by the same method, so as to generate a temporary feature matrix of 4 columns, 1 row, and 1 channel composed of these 4 product sums in sequence.

It should be noted that the above-mentioned one parallel operation module can perform 4 dot product operations between the first sub-feature matrix and the weight value W1 in parallel. In other words, one parallel operation module can simultaneously generate the above 4 product sums, and these 4 product sums are composed into the temporary feature matrix of 4 columns, 1 row, and 1 channel.

In addition, the element-by-element multiplication operation between the entire second to fourth sub-feature matrices and the weight value W11 can also be completed by the same method to generate other 3 temporary feature matrices of 4 columns, 1 row, and 1 channel. In this way, the 4 temporary feature matrices of 4 columns, 1 row, and 1 channel can be sequentially combined to generate a combination matrix of 4 columns, 1 row, and 1 channel.

It should be noted that as long as the above-mentioned 4 parallel operation modules can be used to process 16 dot product operations between the 4 sub-feature matrices and the weight value W11 in parallel, so as to generate the combined matrix of 4 columns, 1 row, and 1 channel.

In other words, every 4 parallel operation modules can generate the above-mentioned 16 product sums at the same time, and every 4 product sums are sequentially composed into the temporary feature matrix of 4 columns, 1row, and 1 channel, so as to sequentially combine 4 temporary feature matrices to generate the combined matrix of 4 columns, 4 rows, and 1 channel.

By the same method as the above method of generating the combination matrix according to the local feature matrix fmap1 and the weight value W11, other 7 combination matrices can be generated according to the local feature matrix fmap1 and the weight values W12-W18. In this way, each of the 8 combined matrices can be used as a channel to generate a local feature output matrix ofmap of 4 columns, 4 rows, and 8 channels.

It should be noted that as long as 32 parallel operation modules can generate 8 combination matrices of 4 columns, 4 rows, and 1 channel, each combination matrix of 4 columns, 4 rows, and 1 channel is used as a channel. In this way, the local feature output matrix ofmap of 4 columns, 4 rows, and 8 channels can be generated.

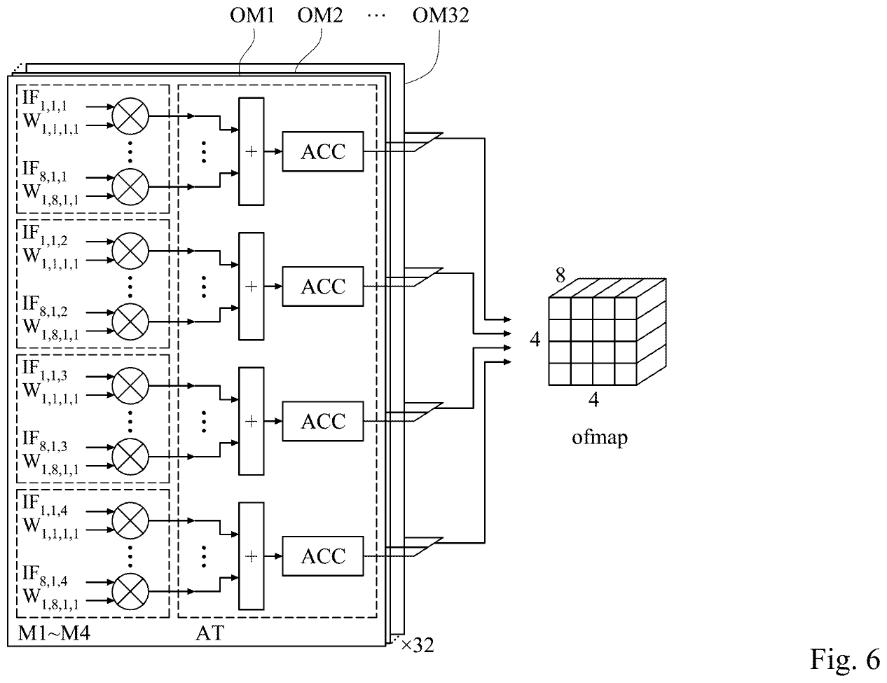

Reference is made to FIG. 6 together, which is a schematic diagram of multiple parallel operation modules OM1-OM32 in some embodiments of the present disclosure. As shown in FIG. 6, the local feature output matrix ofmap of 4 columns, 4 rows, and 8 channels can be generated from the 4 sub-feature matrices and the weight values W11-W18 by 32 parallel operation modules OM1-OM32.

In detail, the parallel operation module OM1 includes 4 multiplier combination modules M1-M4 and 1 adder tree module AT, and each multiplier combination module includes 8 multiplier modules (i.e., there are 32 multiplier modules in total). The multiplier combination modules M1-M4 can be implemented by the multiplier array 120, and the adder tree module AT can be implemented by the tensor combiner 130. The multiplier combination module M1 mainly performs the element-by-element multiplication operation on feature values of 1 column, 1 row, and 8 channels of first one in the first sub-feature matrix with the weight value W11. The multiplier combination module M2 mainly performs the element-by-element multiplication operation on feature values of 1 column, 1 row, and 8 channels of second one in the first sub-feature matrix with the weight value W11. The multiplier combination module M3 mainly performs the element-by-element multiplication operation on feature values of 1 column, 1 row, and 8 channels of third one in the first sub-feature matrix with the weight value W11. The multiplier combination module M4 mainly performs the element-by-element multiplication operation on feature values of 1 column, 1 row, and 8 channels of fourth one in the first sub-feature matrix with the weight value W11.

Further, the multiplier combination module M1 can multiply elements IF_{1, 1, 1}-IF_{8, 1, 1} with elements W_{1, 1, 1, 1}-W1, 8, 1, 1 respectively, and the adder tree module AT can sum the generated product values by the adder module to generate a first product sum. The multiplier combination module M2 can multiply elements IF_{1, 1, 2}-IF_{8, 1, 2} with the elements W_{1, 1, 1, 1}-W_{1, 8, 1, 1} respectively, and the adder tree module AT can sum the generated product values by the adder module to generate a second product sum. The multiplier combination module M3 can multiply elements IF_{1, 1, 3}-IF_{8, 1, 3} with the elements W_{1, 1, 1, 1}-W_{1, 8, 1, 1} respectively, and the adder tree module AT can sum the generated product values by the adder module to generate a third product sum. The multiplier combination module M4 can multiply elements IF_{1, 1, 4}-IF_{8, 1, 4} with the elements W_{1, 1, 1, 1}-W_{1, 8, 1, 1} respectively, and the adder tree module AT can sum the generated product values by the adder module to generate a fourth product sum. In this way, the adder tree module AT can store the 4 generated product values in 4 accumulators ACC respectively, and compose a temporary feature matrix of 4 columns, 1 row, and 1 channel with these 4 product sums. By the same structure and operation, the parallel operation modules OM2-OM4 can generate 3 other temporary feature matrices of 4 columns, 1 row, and 1 channel from the second to fourth sub-feature matrices and the weight value W11 respectively.

Next, the temporary feature matrices generated by the parallel operation modules OM1-OM4 can be sequentially used as first to fourth rows to generate a combination matrix of 4 columns, 4 rows, and 1 channel. In other words, every 4 parallel operation modules operate on the same weight value to generate the combination matrix with of 4 columns, 4 rows, and 1 channel. For example, the parallel operation modules OM5-OM8 perform the same operation above for the weight value W12 to generate a combination matrix of 4 columns, 4 rows, and 1 channel, and the parallel operation modules OM9-OM12 perform the same operation above for the weight value W13 to generate a combination matrix of 4 columns, 4 rows, and 1 channel. In this way, the parallel dot product operations between the local feature matrix fmap1 and the weight values W11-W18 can be completed.

By the above-mentioned method, the parallel operation modules OM1-OM32 firstly generate the 8 combination matrices of 4 columns, 4 rows, and 1 channel. Next, the combination matrix generated by the parallel operation modules OM1-OM4 is used as a first channel, and the combination matrix generated by the parallel operation modules OM2-OM8 is used as a second channel. By analogy, the local feature output matrix ofmap of 4 columns, 4 rows, and 8 channels can be generated by the same method.

In other words, by the machine learning optimization method disclosed in the present disclosure, multiple combination matrices (i.e., the parallel dot product operations) can be generated simultaneously by the parallel processing method, and these combination matrices can be combined to generate the local feature output matrix ofmap. In addition, the structure of such parallel operation modules OM1-OM32 can pre-store all the weight values W1-WK in the multiplier array 120 with a size of 32×32, and perform the above-mentioned multiplication operations synchronously. In this way, because there is no need to move and calculate data additionally, this will greatly reduce the resources and time of the entire calculation. This method is to complete the calculation of the local feature output matrix ofmap before proceeding to the next set of calculations, so that the calculation results can be left in the accumulators ACC, minimizing the data movement amount of the partial sums and improving the reuse of data.

Furthermore, as shown in FIG. 5, in the second to ninth cycles CC2-CC9, basically the same calculation as the first cycle is performed, and the only difference is that different local feature matrices and weight values are used.

In detail, in the cycles CC2-CC3, the extraction range of the cycle CC1 continuously moves to the right by one unit until the extraction range includes the elements of last column of the feature tensor matrix Ifmap. In the cycle CC4, the extraction range of the cycle CC1 moves down by one unit. In cycles CC5-CC6, the extraction range of the cycle CC4 continuously moves to the right by one unit until the extraction range includes the elements of last column of the feature tensor matrix Ifmap. In the cycle CC7, the extraction range of the cycle CC4 moves down by one unit. In the cycles CC8-CC9, the extraction range of the cycle CC7 continuously moves to the right by one unit until the extraction range includes the elements of last column of the feature tensor matrix Ifmap. In this way, the local feature matrices fmap2-fmap9 can be partitioned respectively.

In addition, the weight values extracted in the kernels W1-WK are also extracted in the same way as the movement of the above-mentioned extraction range. Furthermore, in the cycles CC1-CC3, the weight values of the first row in the kernels W1-WK are respectively extracted. In the cycles CC4-CC6, the weight values of the second row in the kernels W1-WK are extracted respectively. In the cycles CC7-CC9, the weight values of the third row in the kernels W1-WK are extracted respectively.

Finally, 8 local feature output matrices ofmap of 4 columns, 4 rows, and 8 channels is generated respectively in the cycles CC2-CC9. In this way, the local feature output matrix ofmap generated in the cycles CC1-CC9 can be performed by the element-by-element addition operation to generate a combined feature output matrix of 4 columns, 4 rows, and 8 channels, where the combined feature output matrix is the result of the convolution of the feature tensor matrix Ifmap with the kernels W1-WK, and a quantity of these cycles is equal to a quantity of elements of a single channel of one of the kernels (e.g., in the example of FIG. 5, the quantities of the elements of the kernels W1-WK are all 9, so the quantity of the cycles is also 9). It should be noted that the same column, same row, and same channel in the local feature output matrix ofmap will be accumulated in the same accumulator ACC to complete the above-mentioned element-by-element addition operation.

In addition, as shown in FIG. 2, each of the feature tensor matrices Ifmap1-Ifmap4 can calculate a combined feature output matrix with the core W1-WK, and combine these combined feature output matrices cfmap1-cfmap4 according to corresponding positions of the feature tensor matrices Ifmap1-Ifmap4, so as to generate the original matrix fmap and the operation result Ofmap of the convolution operation between the kernels W1-WK. Therefore, advantages of KC-partitioning calculation in a weight domain and a channel domain and advantages of XY-partitioning calculation in the column domain and the row domain will be combined to achieve the effect of calculation acceleration.

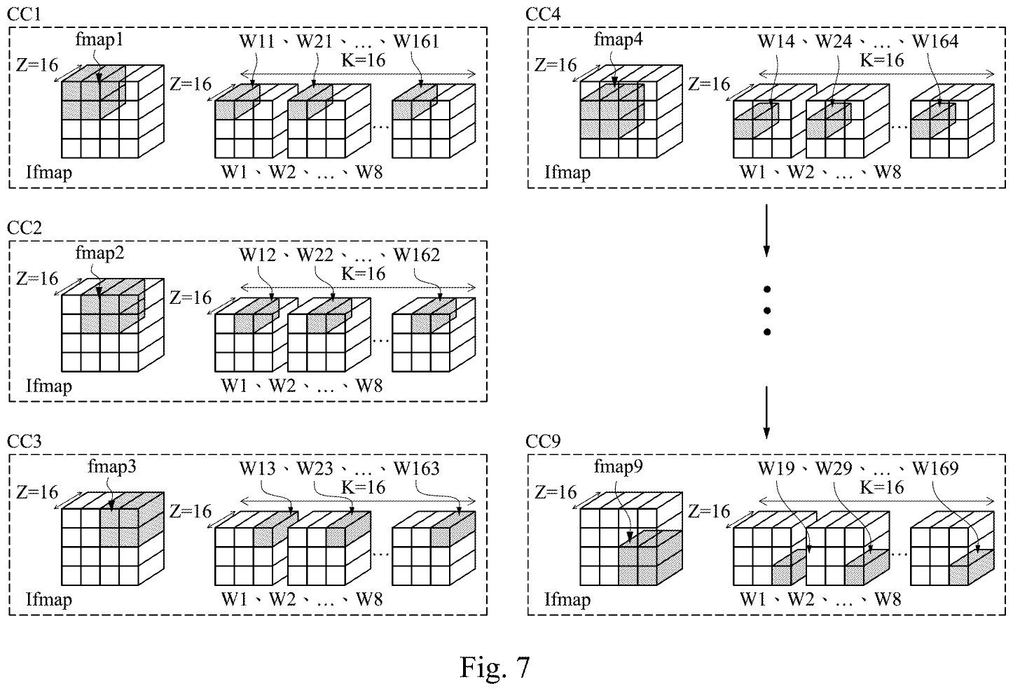

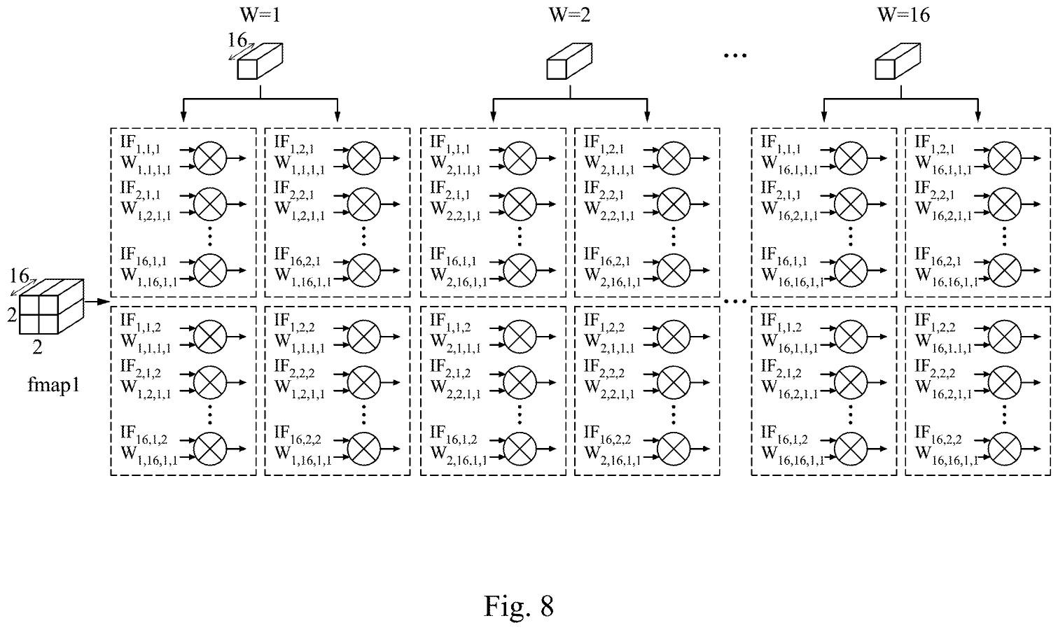

Reference is made to FIG. 7 and FIG. 8 together, where FIG. 7 is a schematic diagram illustrating the processing of the feature tensor matrix Ifmap according to other embodiments of the present disclosure, and FIG. 8 is a schematic diagram illustrating the element-by-element multiplication operation according to other embodiments of the present disclosure. As shown in FIGS. 7 and 8, assuming that that the feature tensor matrix Ifmap includes feature values of 4 columns, 4 rows, and 16 channels, and X, Y, Z, K, M, N (i.e., the operation parameter LP) are 2, 2, 16, 16, 3, 3 respectively, and two feature values of 2 columns, 1 row and 8 channels are partitioned in each cycle (at this time, W is equal to Y), the method of generating the local feature output matrix ofmap of 2 columns, 2 rows, and 16 channels and the combined feature output matrix of 2 columns, 2 rows, and 16 channels is basically the same as the embodiment in FIG. 4 to FIG. 6, but the difference only lies in the structural differences between the parallel operation modules OM1-OM32. Therefore, this will be further described below, and the rest of the same parts will not be repeated.

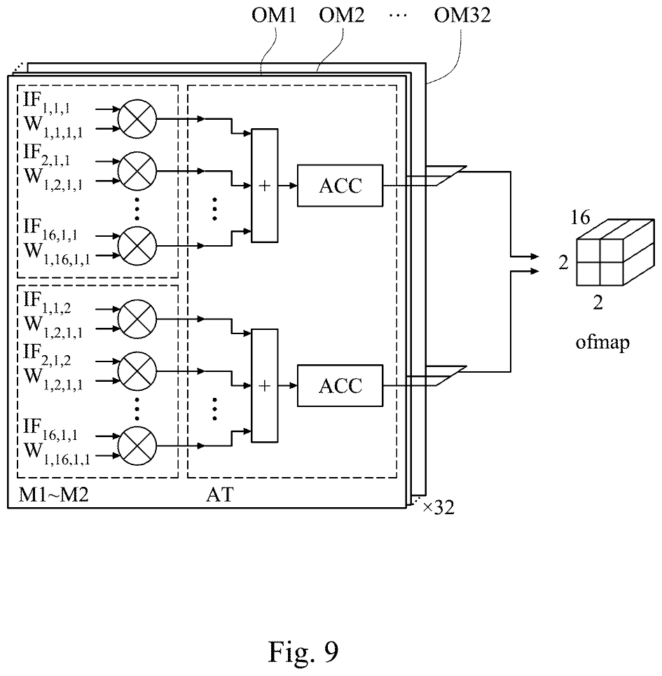

Reference is made to FIG. 9 together, which is a schematic diagram illustrating multiple parallel operation modules OM1-OM32 in other embodiments of the present disclosure. As shown in FIG. 9, by 32 parallel operation modules OM1-OM32, a local feature output matrix ofmap of 2 columns, 2 rows, and 16 channels can be generated from 2 sub-feature matrices and weight values W11-W161.

In detail, the parallel operation module OM1 includes 2 multiplier combination modules M1-M2 and 1 adder tree module AT, and each multiplier combination module includes 16 multiplier modules (i.e., there are 32 multiplier modules in total). The multiplier combination modules M1-M2 can be implemented by the multiplier array 120, and the adder tree module AT can be implemented by the tensor combiner 130. The multiplier combination module M1 mainly performs the element-by-element multiplication operation on the feature values of 1 column, 1 row, and 16 channels of first one in the first sub-feature matrix with the weight value W11. The multiplier combination module M2 mainly performs the element-by-element multiplication operation on feature values of 1 column, 1 row, and 16 channels of second one in the first sub-feature matrix with the weight value W11.

Further, the multiplier combination module M1 can multiply elements IF_{1, 1, 1}-IF_{16, 1, 1} with elements W_{1, 1, 1, 1}-W_{1, 16, 1, 1} respectively, and the adder tree module AT can sum the generated product values by the adder module to generate a first product sum. The multiplier combination module M2 can multiply the elements IF_{1, 1, 2}-IF_{16, 1, 2} with the elements W_{1, 1, 1, 1}-W_{1, 16, 1, 1} respectively, and the adder tree module AT can sum the generated product values by the adder module to generate a second product sum. In this way, the adder tree module AT can store the 2 generated product values in 2 accumulators ACC respectively, and compose a temporary feature matrix of 2 columns, 1 row, and 1 channel with these 2 product sums. By the same structure and operation, the parallel operation module OM2 can generate another temporary feature matrix of 2 columns, 1 row, and 1 channel from the second sub-feature matrix and the weight value W11. Next, the temporary feature matrices generated by the parallel operation modules OM1-OM2 can be sequentially used as the first to second rows to generate a combination matrix of 2 columns, 2 rows and 1 channel. In other words, every 2 parallel operation modules operate on the same weight value to generate the combination matrix of 2 columns, 2 rows and 1 channel. For example, the parallel operation modules OM3-OM4 perform the same operation above for the weight value W12 to generate a combination matrix of 2 columns, 2 rows and 1 channel, and the parallel operation modules OM5-OM6 perform the same operation above for the weight value W13 to generate a combination matrix of 2 columns, 2 rows and 1 channel. In this way, the parallel dot product operations between the local feature matrix fmap1 and the weight values W11-W161 can be completed.

By the above-mentioned method, the parallel operation modules OM1-OM32 firstly generate the 16 combination matrices of 2 columns, 2 rows and 1 channel. Next, the combination matrix generated by the parallel operation modules OM1-OM2 is used as a first channel, and the combination matrix generated by the parallel operation modules OM3-OM4 is used as a second channel. By analogy, the local feature output matrix ofmap of 2 columns, 2 rows, and 16 channels can be generated by the same method.

It should be noted that the size of the local feature matrix fmap1 affects the quantity of the multiplier modules, the quantity of the adder modules and the quantity of the accumulators ACC, and the size of the local feature matrix fmap1 and the quantity of the weight values W11-W161 affects the quantity of the parallel operation modules OM1-OM32. In addition, the size of the weight values W11-W161 does not be set too large, therefore, the quantity of the required cycles does not be too much, which also greatly reduces the calculation time. On the other hand, although the above embodiments adopt such multiplication operation, in practical applications, as long as the dot product between the local feature matrices fmap1-fmap9 and the kernels W1-W16 can be completed. However, combinations of such multiplier modules are not limited.

In summary, the machine learning optimization method and circuit proposed in the present disclosure using multiple parallel operation modules to perform parallel dot product operations will greatly save computing resources, so as to complete the convolution calculation between the feature map and the weight in several cycles. In addition, the feature map can be partitioned in advance, and the convolution calculation between these partitioned parts and weights can be performed, and finally combined. This will combine the advantages of KC-partitioning calculation in a weight domain and a channel domain and the advantages of XY-partitioning calculation in the column domain and the row domain, so as to achieve the effect of calculation acceleration, and minimizing the data movement amount of the partial sums and improving the reuse of data.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A machine learning optimization method, comprising steps of:
generating a local feature matrix from an extraction range in a feature tensor matrix, wherein the local feature matrix comprises feature values of X columns, Y rows, and Z channels;
partitioning W sub-feature matrices from the local feature matrix, wherein each of the W sub-feature matrices comprises X×Y×Z/W feature values;
simultaneously performing parallel dot product operations on the W sub-feature matrices by W×K parallel operation modules to generate W×K temporary feature matrices, wherein the W×K parallel operation modules correspond to K kernels, each of the kernels comprises weight values of M columns, N rows, and Z channels, and each of temporary feature matrices comprises X×Y/W feature values, wherein the parallel dot product operation comprises:
each of the parallel operation modules is configured for multiplying one of the weight values of the single kernel by the X×Y×Z/W feature values, and every W parallel operation modules is configured for multiplying the one of the weight values of the single kernel by the feature values of X columns, Y rows, and Z channels; and
integrating the W×K temporary feature matrices into a local feature output matrix corresponding to the local feature matrix, wherein the local feature output matrix comprises feature values of X columns, Y rows, and Z channels.

2. The machine learning optimization method of claim 1, wherein each of the parallel operation modules comprises X×Y×K/W multiplier modules and an adder tree module, and the parallel dot product operation further comprises steps of:
performing an element-by-element multiplication operation on the X×Y×Z/W feature values in one of the sub-feature matrices with the one of the weight values of the single kernel by the X×Y×K/W multiplier modules, so as to generate X×Y×K/W product values; and
converting the X×Y×K/W product values into one of the temporary feature matrices by the adder tree module.

3. The machine learning optimization method of claim 2, wherein the adder tree module comprises X×Y/W accumulator modules, wherein the step of performing the element-by-element multiplication operation on the X×Y×Z/W feature values in the one of the sub-feature matrices with the one of the weight values of the single kernel by the X×Y×K/W multiplier modules, so as to generate the X×Y×K/W product values comprises a step of:
summing every Z product values by the adder tree module to generate X×Y/W product sums, and storing the X×Y/W product sums in the X×Y/W accumulator modules in the adder tree module.

4. The machine learning optimization method of claim 1, wherein the step of integrating the W×K temporary feature matrices into the local feature output matrix corresponding to the local feature matrix comprises a step of:
combining every W temporary feature matrices in sequence to generate K combination matrices, and integrating the K combination matrices into the local feature output matrix, wherein each of combination matrices comprises feature values of X columns, Y rows, and 1 channel.

5. The machine learning optimization method of claim 1, further comprising steps of:
generating another local feature matrix from another extraction range in the feature tensor matrix, and the other local feature matrix comprises feature values of X columns, Y rows, and Z channels;
partitioning W other sub-feature matrices from the other local feature matrix, wherein each of the W other sub-feature matrices comprises X×Y×Z/W feature values; and
simultaneously performing parallel dot product operations on the W sub-feature matrices by W×K parallel operation modules to generate W×K other temporary feature matrices, and integrating the W×K other temporary feature matrices into another local feature output matrix corresponding to the other local feature matrix, wherein the other local feature output matrix comprises feature values of X columns, Y rows, and Z channels.

6. The machine learning optimization method of claim 5, further comprising a step of:
performing an element-by-element addition operation on the local feature output matrix with the other local feature output matrix, so as to generate a combined feature output matrix.

7. The machine learning optimization method of claim 1, further comprising a step of:
partitioning an original matrix into a plurality of parts, and using one of the plurality of parts as the feature tensor matrix, wherein the original matrix comprises feature values of 2x(X+N−1) columns, 2×(Y+M−1) rows, and Z channels.

8. The machine learning optimization method of claim 1, wherein a quantity of the parallel operation modules is equal to a product of a quantity of columns of the local feature matrix and a quantity of kernels.

9. The machine learning optimization method of claim 1, further comprising a step of:
partitioning the local feature matrix from the extraction range in the feature tensor matrix according to an operation parameter, wherein the operational parameters comprises a column parameter, a row parameter, a kernel parameter, and a channel parameter.

10. The machine learning optimization method of claim 9, wherein the column parameter indicates a quantity of columns in the extraction range, the row parameter indicates a quantity of rows in the extraction range, the kernel parameter indicates a quantity of the kernels, and the channel parameter indicates a quantity of channels of the extraction range.

11. A machine learning optimization circuit, comprising:
a data dispatcher, wherein the data dispatcher is configured for generating a local feature matrix from an extraction range in a feature tensor matrix, and the local feature matrix comprises feature values of X columns, Y rows, and Z channels, wherein the data dispatcher is further configured for partitioning W sub-feature matrices from the local feature matrix, wherein each of the W sub-feature matrices comprises X×Y×Z/W feature values;
a multiplier array, connected to the data dispatcher; and
a tensor combiner, connected to the multiplier array, wherein the multiplier array and the tensor combiner are configured for simultaneously performing parallel dot product operations on the W sub-feature matrices by W×K parallel operation modules to generate W×K temporary feature matrices, wherein the W×K parallel operation modules correspond to K kernels, each of the kernels comprises weight values of M columns, N rows, and Z channels, and each of temporary feature matrices comprises X×Y/W feature values, wherein the parallel dot product operation comprises:
each of the parallel operation modules is configured for multiplying one of the weight values of the single kernel by the X×Y×Z/W feature values, and every W parallel operation modules is configured for multiplying the one of the weight values of the single kernel by the feature values of X columns, Y rows, and Z channels, wherein the multiplier array is further configured for integrating the W×K temporary feature matrices into a local feature output matrix corresponding to the local feature matrix, wherein the local feature output matrix comprises feature values of X columns, Y rows, and Z channels.

12. The machine learning optimization circuit of claim 11, wherein each of the parallel operation modules comprises X×Y×K/W multiplier modules and an adder tree module, and the parallel dot product operation further comprises steps of:
performing an element-by-element multiplication operation on the X×Y×Z/W feature values in one of the sub-feature matrices with the one of the weight values of the single kernel by the X×Y×K/W multiplier modules, so as to generate X×Y×K/W product values; and
converting the X×Y×K/W product values into one of the temporary feature matrices by the adder tree module.

13. The machine learning optimization circuit of claim 12, wherein the adder tree module comprises X×Y/W accumulator modules, wherein the operation of performing the element-by-element multiplication operation on the X×Y×Z/W feature values in the one of the sub-feature matrices with the one of the weight values of the single kernel by the X×Y×K/W multiplier modules, so as to generate the X×Y×K/W product values comprises a step of:
summing every Z product values by the adder tree module to generate X×Y/W product sums, and storing the X×Y/W product sums in the X×Y/W accumulator modules in the adder tree module.

14. The machine learning optimization circuit of claim 11, wherein the operation of integrating the W×K temporary feature matrices into the local feature output matrix corresponding to the local feature matrix comprises a step of:
combining every W temporary feature matrices in sequence to generate K combination matrices, and integrating the K combination matrices into the local feature output matrix, wherein each of combination matrices comprises feature values of X columns, Y rows, and 1 channel.

15. The machine learning optimization circuit of claim 11, wherein the data dispatcher is further configured for:
generating another local feature matrix from another extraction range in the feature tensor matrix, and the other local feature matrix comprises feature values of X columns, Y rows, and Z channels; and
partitioning W other sub-feature matrices from the other local feature matrix, wherein each of the W other sub-feature matrices comprises X×Y×Z/W feature values, wherein the multiplier array and the tensor combiner are further configured for:
simultaneously performing parallel dot product operations on the W sub-feature matrices by W×K parallel operation modules to generate W×K other temporary feature matrices, and integrating the W×K other temporary feature matrices into another local feature output matrix corresponding to the other local feature matrix, wherein the other local feature output matrix comprises feature values of X columns, Y rows, and Z channels.

16. The machine learning optimization circuit of claim 15, wherein the tensor combiner is further configured for:
performing an element-by-element addition operation on the local feature output matrix with the other local feature output matrix, so as to generate a combined feature output matrix.

17. The machine learning optimization circuit of claim 11, wherein the data dispatcher is further configured for:
partitioning an original matrix into a plurality of parts, and using one of the plurality of parts as the feature tensor matrix, wherein the original matrix comprises feature values of 2x(X+N−1) columns, 2x(Y+M−1) rows, and Z channels.

18. The machine learning optimization circuit of claim 11, wherein a quantity of the parallel operation modules is equal to a product of a quantity of columns of the local feature matrix and a quantity of kernels.

19. The machine learning optimization circuit of claim 11, wherein the data dispatcher is further configured for:
partitioning the local feature matrix from the extraction range in the feature tensor matrix according to an operation parameter, wherein the operational parameters comprises a column parameter, a row parameter, a kernel parameter, and a channel parameter.

20. The machine learning optimization circuit of claim 19, wherein the column parameter indicates a quantity of columns in the extraction range, the row parameter indicates a quantity of rows in the extraction range, the kernel parameter indicates a quantity of the kernels, and the channel parameter indicates a quantity of channels of the extraction range.
